(19) United States
(12) Patent Application Publication
(10) Pub. No.: US 2026/0219169 A1
(43) Pub. Date: Jul. 30, 2026

(54) IN-LINE SPECTROMETER FOR PRODUCTION OF COLORED GRANULES

(71) Applicant: Ampacet Corporation, Tarrytown, NY (US)

(72) Inventors: Eli MARGALIT, Moshav Y'aad (IL); Dan Vadim REGELMAN, Kiryat Bialik (IL); Daniel HOFMANN, Haifa (IL); Gustavo LIDZKI, Rye Brook, NY (US)

(73) Assignee: Ampacet Corporation, Tarrytown, NY (US)

(21) Appl. No.: 19/455,444

(22) Filed: Jan. 21, 2026

Related U.S. Application Data
(60) Provisional application No. 63/749,141, filed on Jan. 24, 2025.

(51) Int. Cl. G01N 21/25; G01N 1/20; G01N 21/84; G01N 21/85

(52) U.S. Cl. CPC G01N 21/251; G01N 1/2035; G01N 21/255; G01N 21/85; G01N 2001/2007; G01N 2021/8411; G01N 2021/8592

(57) ABSTRACT

A system for producing colored granules includes a plurality of material feeders to feed corresponding materials; a control unit controlling the plurality of material feeders in accord with a pigment recipe for producing colored granules of a target color; a processing machine that receives combined feeds from the plurality of material feeders, as fed under control of the control unit, to produce and output colored granules with the target color according to the pigment recipe; and a color assessment unit for receiving colored granules output from the processing machine. The color assessment unit having an in-line spectrometer in signal communication with the control unit for delivering spectral signals to the control unit informing the color of colored granules output from the processing machine for use by the control unit to adjust controls of the material feeders for effecting color corrections to colored granules produced by the processing machine.

### FIELD OF THE INVENTION

The present invention relates to systems and methods for producing colored granules, and in particular, colored granules with substantially uniform coloration for subsequent use in manufacturing plastic products.

### BACKGROUND OF THE INVENTION

Plastic products are typically manufactured by feeding one or more polymers and one or more masterbatches into a processing machine (e.g., an injection molding, blow molding, extrusion machines) to produce a final plastic product. The polymer is a plastic material for formation of the plastic product and may also commonly be referred to as a “resin”, “raw material”, or “virgin”. The masterbatches are concentrated mixtures of pigments and/or additives that have been encapsulated in a carrier resin and pelletized. The polymer and masterbatches are fed in small particle forms that may be referred to interchangeably as “pellets”, “beads”, and “granules”, and which typically have a weight in a range of 0.01 g-0.04 g.

Conventionally, the production of a colored plastic product is achieved by feeding the polymer together with a pigment masterbatch composed of a predetermined mixture of colorized pellets or powder pigments of varying colors. The composition of a given pigment masterbatch is based on a pigment recipe that dictates the percentages of the varying powder pigments or colorized pellets as needed for achieving a target color for a final plastic product, which is determined in advance based on the natural color of the polymer with which the pigment masterbatch is to be mixed for forming the plastic product. In other words, a pigment recipe provides a specific formula of various colors, and quantities of each, needed for adjusting the natural color of a specific polymer to achieve a target color for a final plastic product.

However, even when using specially formulated pigment recipes, it is not uncommon for conventional practices to yield batches of colored granules with inconsistent coloration, with individual pellets in a single production batch having various shades of a target color. This can result from unexpected variations in one or more of the component materials, such as compositional impurities in the polymer material used for the carrier resin. Granule batches with non-uniform coloration may yield coloration inconsistencies in the subsequent production of a colored plastic product or may simply be discarded as unusable product, thereby increasing waste and lost costs.

There thus remains a need in the art for further improving the reliability of accurately achieving target colors in the production of colored granules for use in the manufacture of plastic products.

### SUMMARY OF THE INVENTION

A system for production of colored granules comprises a plurality of material feeders, each adapted for feeding metered quantities of a corresponding material; a control unit configured to control operation of the plurality of material feeders to feed the corresponding materials at predetermined feed rates in accord with a pigment recipe formulated for producing colored granules of a target color; a processing machine for receiving the combined feeds from the plurality of material feeders, as fed under control of the control unit, and configured to extrude and pelletize the combined feeds to produce and output colored granules; and a color assessment unit for receiving colored granules output from the processing machine, the color assessment unit having two flow paths, with a first flow path for feeding a first portion of granules along a primary production feed path, and a second flow path for diverting a second portion of granules along a secondary feed path for color assessment by an in-line spectrometer in signal communication with the control unit for delivering spectral signals to the control unit informing on the color of colored granules output from the processing machine.

The color assessment unit comprises a collection vessel for receiving colored granules from the processing machine and an optical analyzer for assessing the coloration of colored granules. The collection vessel comprises a distribution outlet for feeding colored granules to a distribution line for distributing colored granules to a downstream destination and a sampling outlet for feeding colored granules to a sampling line. The optical analyzer comprises an optical spectrometer for measuring the coloration of colored granules and a conveyor for transporting colored granules through an optical field of the optical spectrometer. The sampling line is arranged to deliver colored granules from the sampling outlet of the collection vessel to the conveyor of the optical analyzer and the conveyor is arranged to feed colored granules back to the collection vessel for distribution via the distribution outlet.

The collection vessel comprises an inlet chamber for receiving colored granules from the upstream processing machine and an outlet chamber for distributing colored granules to a downstream location, the inlet chamber and outlet chamber being in flow communication for the flow of colored granules from the inlet chamber to the outlet chamber, with the sampling outlet located in the inlet chamber and the distribution outlet located in the outlet chamber.

The optical analyzer further comprises a venturi pump for generating a vacuum force in the sampling line to draw colored granules through the sampling outlet in the inlet chamber for delivery to the conveyor and a control module for controlling the venturi pump to draw a first quantity of colored granules through the sampling outlet while a second quantity of colored granules flows from the inlet chamber to the outlet chamber, the first quantity being less than the second quantity.

The conveyor of the optical analyzer is configured to feed colored granules that were received from the inlet chamber of the collection vessel, and then transported through the optical field of the optical spectrometer, to the outlet chamber of the collection vessel. The conveyor is preferably a vibratory conveyor comprising a channel and a vibratory mechanism configured to vibrate the channel for conveying colored granules through the optical field of the optical spectrometer.

The color assessment unit is configured for continuously drawing colored granules through the sampling outlet in the inlet chamber to continuously monitor the coloration of colored granules throughout a production run of colored granules, with the optical spectrometer configured to continuously transmit spectral signals to a control unit of an upstream system configured for producing colored granules, the spectral signals informing the coloration of colored granules as measured by the optical spectrometer for real-time monitoring and correction of the coloration of colored granules produced by the processing machine.

Systems according to the present invention are inclusive of the color assessment unit along with a control unit configured to control operation of the plurality of material feeders for feeding corresponding materials at predetermined feed rates in accord with a pigment recipe formulated for producing colored granules of a target color, with the control configured to use spectral signals received from the optical spectrometer of the color assessment unit to: calculate a color-deviation (ΔE) between coloration of the colored granules assessed by the optical spectrometer and the target color according to the pigment recipe; calculate a color correction to alter coloration of subsequently produced colored granules to reduce the calculated color-deviation (ΔE); and adjust control operations of the plurality of material feeders in accord with the color correction. The control unit is configured to compare the calculated color-deviation (ΔE) with a predetermined color-deviation threshold (ΔEp), and to calculate a color correction and adjust control operations of the plurality of material feeders in accord with the color correction only when the color-deviation (ΔE) exceeds the color-deviation threshold (ΔEp). The control unit is configured to continuously calculate color-deviations (ΔE) based on signals received from the optical spectrometer and continuously adjust control operations of the plurality of material feeders in accord with the calculated color corrections in real-time.

The present invention is also inclusive of methods of retrofitting systems for producing colored granules to utilize the color assessment unit by positioning the color assessment unit at the outlet of a processing machine in the system for the reception of colored granules output from the processing machine into the collection vessel of the color assessment unit; establishing signal communication between the optical spectrometer of the color assessment unit and a control unit of the system; and configuring the control unit of the system to control operation of the plurality of material feeders based, in part, on spectral signals received from the optical spectrometer of the color assessment unit.

Both the foregoing general description and the following detailed description are exemplary and explanatory only and are intended to provide further explanation of the invention as claimed. The accompanying drawings are included to provide a further understanding of the invention; are incorporated in and constitute part of this specification; illustrate embodiments of the invention; and, together with the description, serve to explain the principles of the invention.

### BRIEF DESCRIPTION OF THE DRAWINGS

Further features and advantages of the invention can be ascertained from the following detailed description that is provided in connection with the drawings described below:

FIG. 1 shows an example of a granule producing system according to the present invention.

FIG. 2A shows a flow-path schematic for material feeds in the system in FIG. 1, when the system is configured as a continuous loss-in-weight gravimetric blending system.

FIG. 2B shows a flow-path schematic for material feeds in the system in FIG. 1, when the system is configured as a gravimetric batch blending system.

FIG. 3 shows the color assessment unit in the system in FIG. 1 in isolation.

FIGS. 4A-4D show the collection vessel of the color assessment unit in FIG. 3 in isolation, with FIG. 4A showing an isometric view of the collection vessel; FIG. 4B showing a top plan view of the collection vessel; FIG. 4C showing a front elevation view of the collection vessel; and FIG. 4D showing a cross-sectional view of the collection vessel as seen along line IVD in FIG. 4C.

FIGS. 5A-5C show the optical analyzer of the color assessment unit in FIG. 3 in isolation, with FIG. 5A showing an isometric view of the optical analyzer; FIG. 5B showing a front elevation view of the optical analyzer; and FIG. 5C showing a side elevation view of the optical analyzer.

FIG. 6 shows real-time monitoring and correction of color-deviation in colored granules using the system in FIG. 1.

FIG. 7 shows a schematic for a control unit in the system in FIG. 1.

### DETAILED DESCRIPTION OF THE INVENTION

The following disclosure discusses the present invention with reference to the examples shown in the accompanying drawings, though does not limit the invention to those examples.

The use of examples, or exemplary language (e.g., “such as”) provided herein is intended merely to better illuminate the invention and does not pose a limitation on the scope of the invention unless otherwise claimed. No language in the specification should be construed as indicating any non-claimed element as essential or otherwise critical to the practice of the invention, unless otherwise made clear in context.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements.

The word “substantially,” as used herein with respect to any property or circumstance, refers to a degree of deviation that is sufficiently small so as to not appreciably detract from the identified property or circumstance. The exact degree of deviation allowable in a given circumstance will depend on the specific context, as would be understood by one having ordinary skill in the art.

Use of the terms “about” or “approximately” are intended to describe values above and/or below a stated value or range, as would be understood by one having ordinary skill in the art in the respective context. In some instances, this may encompass values in a range of approx. +/−10%; in other instances, there may be encompassed values in a range of approx. +/−5%; in yet other instances values in a range of approx. +/−2% may be encompassed; and in yet further instances, this may encompass values in a range of approx. +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context.

Recitations of value ranges herein, unless indicated otherwise, serve as shorthand for referring individually to each separate value falling within the respective ranges, including the endpoints of the range, each separate value within the range, and all intermediate ranges subsumed by the overall range, with each incorporated into the specification as if individually recited herein.

Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted.

The present invention is inclusive of systems and methods for production of colored granules, in particular, colored granules for use in subsequent manufacturing of plastic products, which may include masterbatches in the form of pelletized concentrated mixtures of pigments and additives encapsulated in a carrier resin as well as color compounds in the form of pelletized concentrated mixtures of pigments with a pre-colored or natural-colored resin base material.

Systems and methods according to the present invention use feedback output from an in-line spectrometer and received at a control unit for controlling the feed rates of materials from a plurality of material feeders to achieve a target color of the produced colored granules.

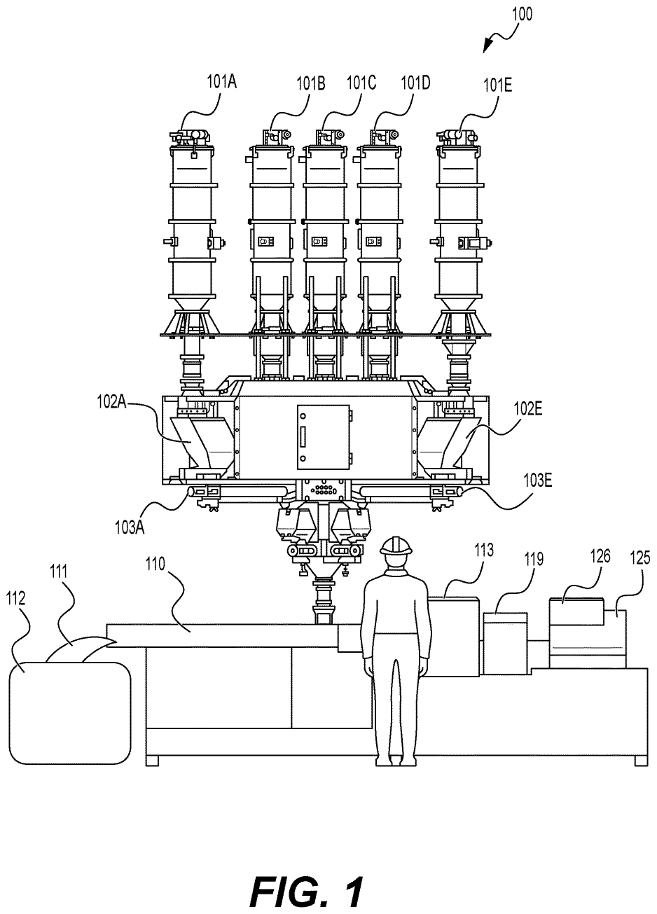

FIG. 1 shows an example of a system 100 according to the present invention, with a plurality of supply sources 101 (101a-101e), each with a material feeder 102 (102a-102e) for feeding a corresponding material, with at least one supply source 101 containing a polymer for use as a carrier resin and the remaining supply sources 101 containing pigments and/or additives for mixing with the polymer in accord with a pigment recipe for production of colored granules having a target color. A control unit 113 controls feed rates of the material feeders 102 for feeding corresponding materials to a downstream processing machine 110 that receives the combined material feeds, and extrudes and pelletizes the combined material feeds to produce and output colored granules 111. A color assessment unit 112 is provided for receiving the colored granules 111 output from the processing machine 110.

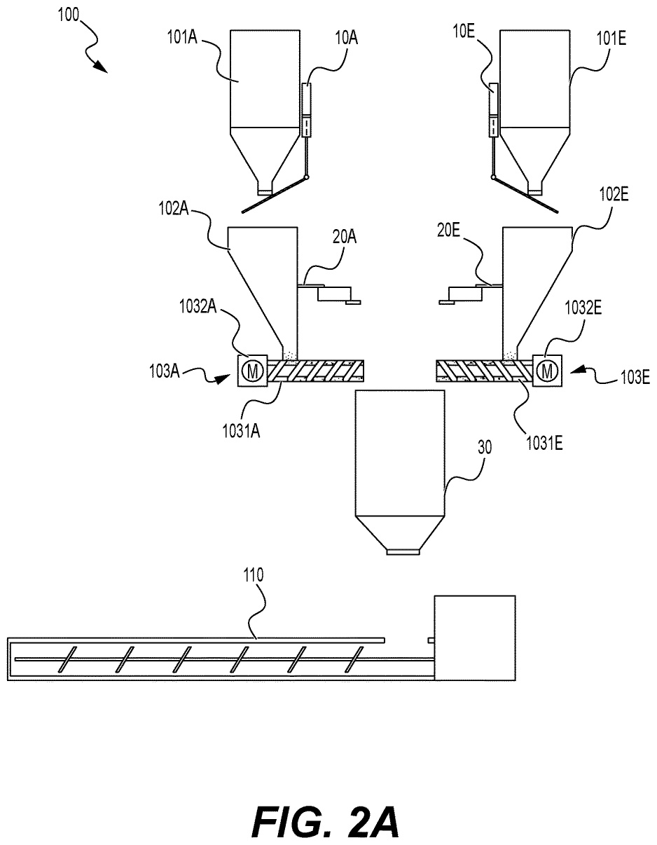

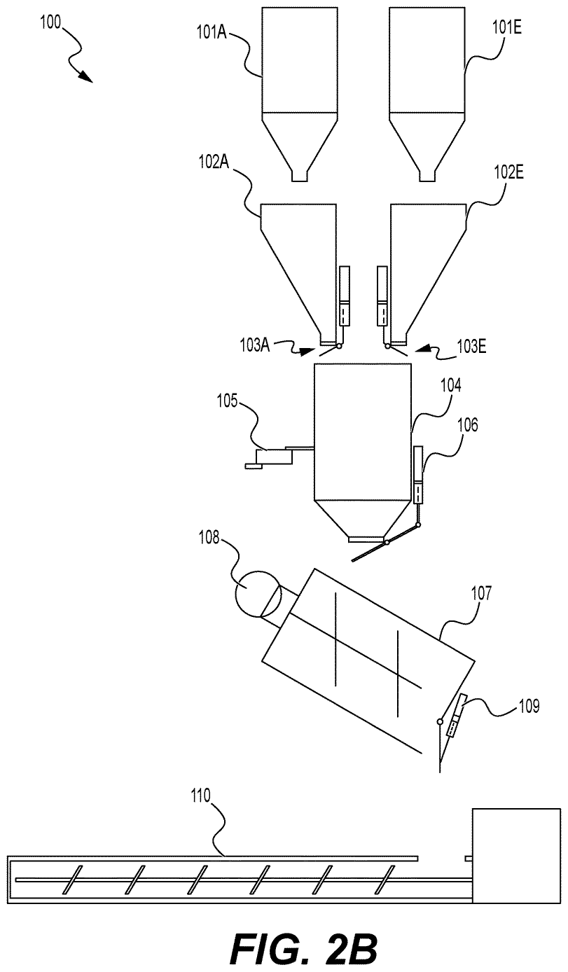

FIG. 2A shows a flow-path schematic for an example of the system 100 that is configured as a continuous loss-in-weight gravimetric blending system. Though this schematic shows representations for material flow only relative to material supply sources 101a and 101e, it will be understood that the same applies to the remaining supply sources 101b-101d. As seen in FIG. 3A, each supply source 101 is provided with a gate unit 10 for feeding metered doses of the corresponding material to a downstream material feeder 102. Each material feeder 102 is provided with a load cell 20 and a metered feeding mechanism 103 for feeding predetermined quantities of the material stored in the corresponding supply source 101 (e.g., polymers, pigments, additives, etc.). The material feeders 102 may be any suitable type of material feeder depending on the nature of the system, with an appropriate feeding mechanism 103 for the same. For example, material feeders 102 may be gravimetric feeders, volumetric feeders, liquid feeders, powder feeders, or any other suitable material feeder type; and feeding mechanisms 103 may be motor-driven feed screws, motor-driven conveyer belts, motor-driven vibratory channels, gate units, or any other suitable feeding mechanism. In this illustrated example, the feeding mechanisms 103 are provided in the form of feed screws with a screw channel 1031 for feeding material and a 1032 motor for driving the screw channel 1031. Each feeding mechanism 103 is in material feed communication with a common funnel 30 that receives the combined metered material quantities from each material feeder 102 and directs the combined material feeds to the inlet of a processing machine 110. Processing machine 110 is an extruder that heats and melts the combined material feeds received therein to uniformly disperse the component materials in the production of a molten product as a thoroughly mixed combination with a substantially homogenous and uniform color distribution throughout. The molten product is extruded into strands that are then cooled and cut into uniform pellets to produce and output the colored granules 111. Optionally, the common funnel 30 may be omitted, and the feeding mechanisms 103 of the material feeders 102 may feed the respective material feeds directly into the inlet of the processing machine 110.

FIG. 2B shows a flow-path schematic for an example of the system 100 that is configured as a gravimetric batch blender system. Though this schematic shows representations for material flow only relative to material supply sources 101a and 101e, it will be understood that the same applies to the remaining supply sources 101b-101d. Each supply source 101 feeds to a dedicated material feeder 102 that is adapted to feed predetermined quantities of the material stored in the corresponding supply source 101 (e.g., polymers, pigments, additives, etc.). The material feeders 102 are adapted to feed precise quantities of material via inclusion of a metered feeding mechanism 103. The material feeders 102 may be any suitable type of material feeder depending on the nature of the system, with an appropriate feeding mechanism for the same. For example, material feeders 102 may be volumetric feeders, liquid feeders, powder feeders, or any other suitable material feeder type; and feeding mechanisms 103 may be motor-driven feed screws, motor-driven conveyer belts, motor-driven vibratory channels, gate units, or any other suitable feeding mechanism. In this illustrated example, the feeding mechanisms 103 are provided in the form of gate units. Each feeding mechanism 103 is in material feed communication with a common weighing receptacle 104 that is configured for receiving the combined metered material quantities from each material feeder 102. The weighing receptacle 104 has a load cell 105 for determining a combined weight of the metered materials received therein, and for triggering opening of a gate 106 to release the combined materials upon reaching a predetermined total weight. The weighing receptacle 104 is in material feed communication with a mixing chamber 107 that receives the combined metered materials from the weighing receptacle 104 and mixes the same to produce a homogeneous mixture of the combined material feeds. The mixing chamber 107 is driven by a motor 108 and has a gate 109 that opens after sufficient mixing to feed the homogeneous mixture to a processing machine 110. Processing machine 110 is an extruder that heats and melts the combined material feeds received therein to uniformly disperse the component materials in the production of a molten product as a thoroughly mixed combination with a substantially homogenous and uniform color distribution throughout. The molten product is extruded into strands that are then cooled and cut into uniform pellets to produce and output the colored granules 111.

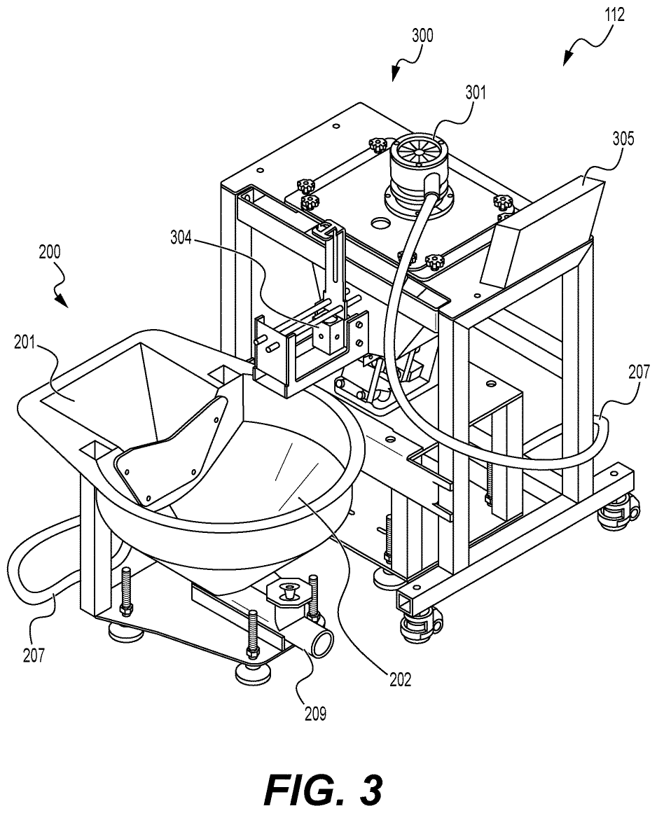

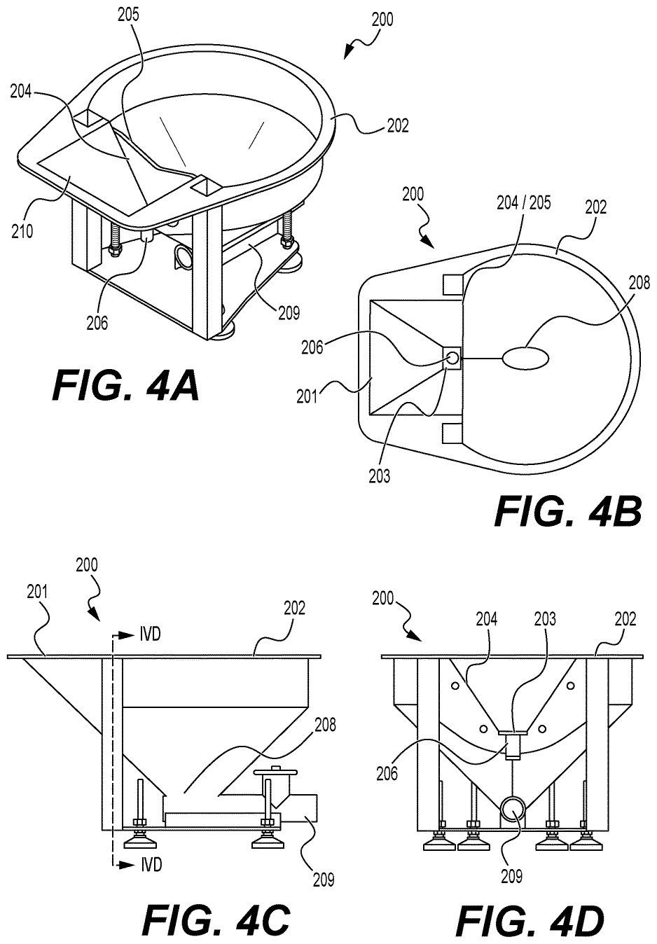

FIG. 3 shows an example of the color assessment unit 112 that includes a collection vessel 200 for receiving colored granules output from the processing machine 110 and an optical analyzer 300 for assessing coloration of granules received at the collection vessel 200. FIGS. 4A-4D show the collection vessel 200 in isolation, and FIGS. 5A-5C show the optical analyzer 300 in isolation.

Collection vessel 200 comprises an upstream inlet chamber 201 and a downstream outlet chamber 202 in flow communication with one another for the passage of granules from the inlet chamber 201 to the outlet chamber 202. The inlet chamber 201 is formed as a truncated, generally pyramidal funnel, with a generally flat bottom surface 203 and one vertical triangular face of the pyramidal shape omitted to form an opening into the outlet chamber 202. The outlet chamber 202 is a formed as conical funnel with a round upper rim, with arcuate portions of the conical funnel and the round rim omitted in regions corresponding with the omitted triangular face of the inlet chamber 201. The omitted regions of the inlet and outlet chambers 201/202 together form a mouth 204 through which granules received in the inlet chamber 201 flow into the outlet chamber 202.

In the illustrated example, a removable and adjustable dam 205 is provided at the mouth 204 between the inlet and outlet chambers 201/202. Dam 205 is releasably secured to the mouth 204 via a number of mating fasteners (e.g., mating threaded bolts and threaded holes, mating clasps, etc.) to form a limited barrier at the mouth 204 with an opening of defined dimensions for the passage of granules from the inlet chamber 201 to the outlet chamber 202. Multiple sets of mating fasteners may be provided to enable selective positioning of the dam 205, with each different position being determined in advance for defining different dimensions for the passage of granules to enable different flow rates for the passage of granules from the inlet chamber 201 to the outlet chamber 202. Optionally, dam 205 may be omitted from the collection vessel 200 and a flow rate of granules from the inlet chamber 201 to the outlet chamber 202 may instead be controlled based on an output feed rate of granules from the processing machine 110 in combination with a shape profile of the inlet chamber 201.

A sampling outlet 206 is provided at the flat bottom surface 203 of the inlet chamber 201 and is in flow communication with a sampling feed line 207 for extracting a sampling quantity of granules received in the inlet chamber 201 for delivery to the optical analyzer 300. The remaining granules not extracted through the sampling outlet 206 as part of the sampling quantity pass through the mouth 204 to the outlet chamber 202. A distribution outlet 208 is provided in outlet chamber 202 and is in flow communication with a distribution feed line 209 for distributing granules to a chosen destination, which may include one or more storage containers and/or one or more plastic product manufacturing machines.

Optical analyzer 300 includes a venturi pump 301 in flow communication with the sampling feed line 207, the venturi pump 301 creating a negative pressure differential to thereby generate a vacuum force in the sampling feed line 207 for drawing granules through the sampling outlet 206 in the inlet chamber 201. Granules drawn through the sampling feed line 207 drop into a silo 302 that outputs the granules to a conveyor 303 that then transports the granules along a conveyance path that passes through a viewing field of an optical spectrometer 304 and subsequently feeds the granules to the outlet chamber 202 of the collection vessel 200. In this way, granules extracted from inlet chamber 201 for assessment by optical analyzer 300 are rejoined with the remaining granules that passed through the mouth 204 for distribution from the outlet chamber 202. In the illustrated example, the conveyor 303 is provided as a vibratory conveyor with a channel 303a and a vibratory drive 303b for vibrating channel 303a to convey granules therealong. In other examples, the conveyor 300 may be provided in other forms with a conveyance pathway and a corresponding drive source (e.g., a conveyor belt and motor).

The optical analyzer 300 further includes a control module 305 for controlling components of the optical analyzer 300, including the venturi pump 301 and the conveyor 303, via a user interface. The control module 305 may include on/off controls that enable a user to select whether the color assessment unit 112 will operate during a given production run of colored granules. The control module 305 may further include controls enabling a user to selectively alter the settings of the venturi pump 301, for example, to increase or decrease an amount of granules (e.g., 1×, 2×, 3×, etc.) that are extracted through the sampling outlet 206 at the inlet chamber 201 and/or change a frequency at which granules are extracted through the sampling outlet 206 (e.g., continuously, x/1 min., x/5 min., etc.). The control module may enable a user to selectively alter the settings of the conveyor 303, for example by altering a power of the vibrational mechanism 303b or other drive mechanism, to increase or decrease a feed rate of granules along the channel 303a or other conveyance path and thus the passage of granules through the optical field of the optical spectrometer 304.

The optical spectrometer 304 is in signal communication with control unit 113 for delivering signals to control unit 113 informing the color of granules that pass through the optical field via conveyor 303. Optical spectrometer 304 continuously assesses spectral properties of colored granules traveling along the conveyor 303 and communicates signals conveying spectral properties to control unit 113 in real-time. The control unit 113 uses signals received from the optical spectrometer 304 to determine L*a*b* color space values for coloration of the colored granules, compares L*a*b* values of the colored granules to L*a*b* values of the intended target color for the colored granules, continuously calculates a color-deviation ΔE between the two sets of L*a*b* values, inclusive of any combination of deviations of ΔL*, Δa*, and Δb*. If the color-deviation ΔE exceeds a predetermined color-deviation threshold ΔEp, the control unit 113 uses stored L*a*b* color space data to calculate a color correction for adjustment of the then current pigment recipe to alter feed rates of one or more of the material feeders 102 to adjust coloration of the colored granules to be within acceptable bounds (i.e., reduce color-deviation ΔE below the color-deviation threshold ΔEp). When the calculated color-deviation ΔE does not exceed the color-deviation threshold ΔEp, the control unit 113 proceeds with control of the material feeders 102 at the then current feed rates. Preferably, the optical spectrometer 304 and the control unit 113 operate continuously and in real-time to repeatedly adjust a pigment recipe as needed during production of colored granules.

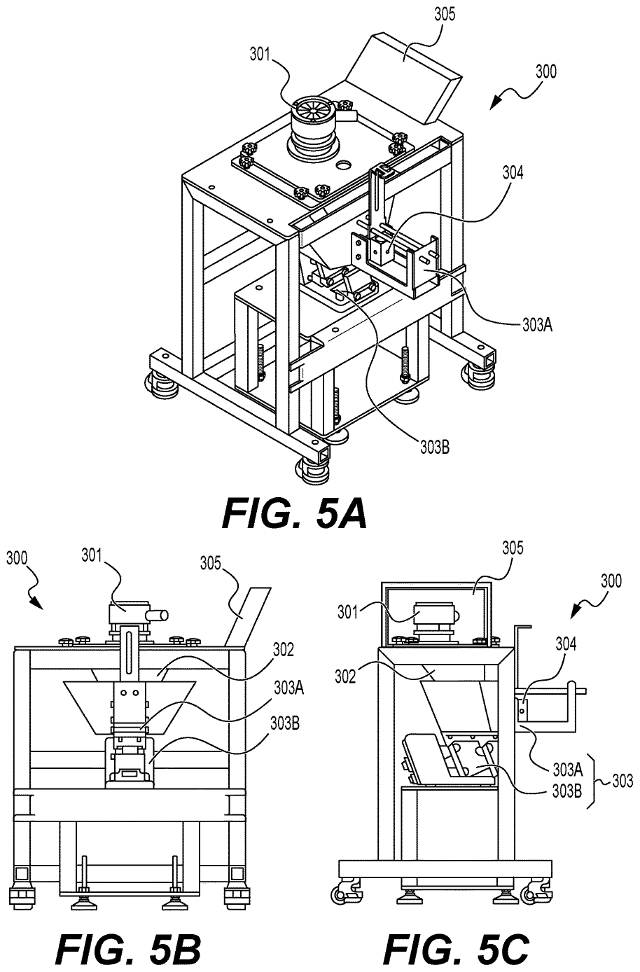

FIG. 6 shows an example of real-time color correction executed by the control unit 113 based on signals from the optical spectrometer 304. In a time period T1-T3, a color-deviation ΔE between the colored granules and the target color is below a predetermined color-deviation threshold ΔEp (ΔEp=0.8), and the control unit 113 therefore continues operation with the then current pigment recipe. In a time period T3-T4, the color-deviation ΔE is equal to the color-deviation threshold ΔEp. In this example, no action is taken as the control unit 113 is programmed to effect a color correction only when the color-deviation ΔE exceeds the color-deviation threshold ΔEp (ΔE>ΔEp), though in other examples the control unit 113 may be programmed to begin color corrections when the color-deviation ΔE is equal to or in excess of the color-deviation threshold ΔEp (ΔE≥ΔEp). At a time T4, the color-deviation ΔE exceeds the color-deviation threshold ΔEp, and the control unit 113 begins color correction to alter coloration of the colored granules to effectively reduce the color-deviation ΔE. In a time period T4-T8, control unit 113 continues color correction by repeatedly recalculating and updating the pigment recipe with color corrections that continually alter coloration of the colored granules to reduce the color-deviation ΔE. At a time T8, the color-deviation ΔE is effectively reduced to a value below the color-deviation threshold ΔEp, and the control unit 113 therefore ceases color correction and continues operation with the then current pigment recipe that resulted from the most recent color correction. In this way, control unit 113 continually monitors and adjusts coloration of the colored granules in real-time.

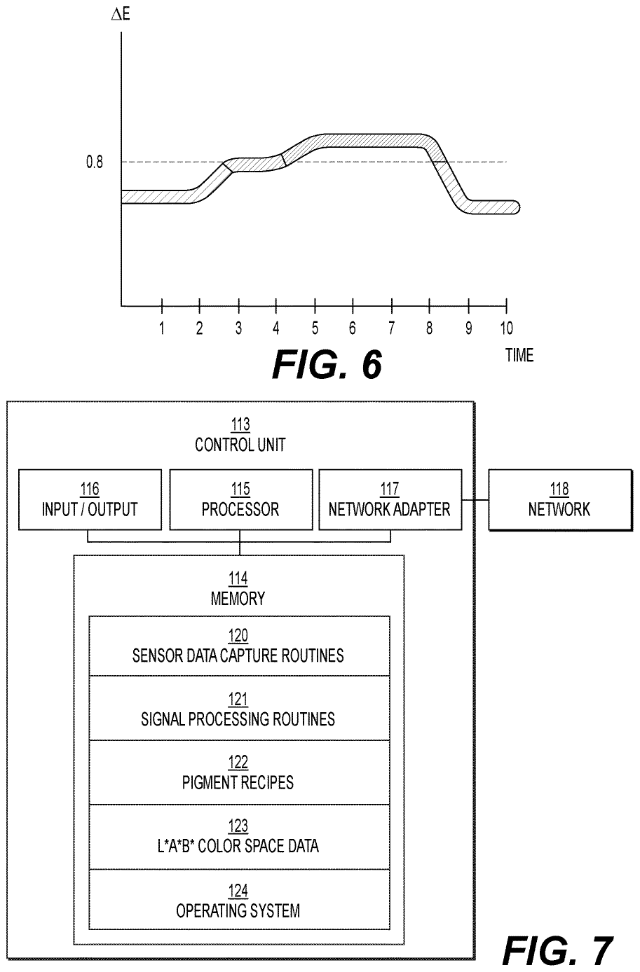

FIG. 7 is a schematic illustration of control unit 113, with a memory 114 adapted for storing data, a processor 115 for reading and executing data stored at the memory 114, and input/output devices 116 for receiving and outputting data. Optionally, a network adapter 117 may also be provided for communication with a network 118, for example, to enable remote updates to data and software stored at memory 114. The input/output devices 116 include an input for the optical spectrometer 304, a user interface 119 (such as a display screen, keyboard, touch screen display, etc.) and any other sensors that may be present in the system 100. Data stored at memory 114 may include, though is not limited to, sensor data capture routines 120, signal processing routines 121, pigment recipes 122, L*a*b* color space data 123, and operational programming 124. Sensor data capture routines 120 include programming for receiving signals from the optical spectrometer 304, as well as any other sensors. Signal processing routines 121 include routines for processing received signals. Pigment recipes 122 include programming with formulations instructing the feeding of material components (e.g., polymers, pigments, additives, etc.) for production of colored granules with specific target colors, and may include formulations preloaded in the memory 114, formulations calculated by the processor 115 from prior production runs, and formulations uploaded to the memory 114 (e.g., via user input or software updates). L*a*b* color space data 123 includes L*a*b* color space mapping coordinates and color correction algorithms for effecting color adjustments in L*a*b* color space coordinates for effecting changes in coloration of colored granules. Color correction algorithms may include correction algorithms preloaded in memory 114, correction algorithms calculated by the processor 115 from prior production runs, and correction algorithms uploaded to memory 114 (e.g., via user input or software updates). Operational programming 124 includes programming and operating systems for operation of system 100 generally.

Data informing the intended target color for a production run of colored granules is stored in memory 114 of the control unit 113. The target color data may be stored as L*a*b* color space data 123 and associated with one or more corresponding pigment recipes 122—for example, with different pigment recipes available for achieving an individual target color based on the use of different polymer components. Control unit 113 may be configured for a user to interact with the user interface 119 to identify a polymer component that is to be used in a production run and a target color for the colored granules to be produced from the production run, with the control unit 113 then identifying an appropriate pigment recipe for achieving the selected target color. Optionally, the system 100 may also include a sampling cabinet 125 with a sampling spectrometer 126 and a reception space (internal) for insertion of a physical reference sample that may be positioned proximate the sampling spectrometer 126. Optionally, the physical reference sample may be a prior produced product with a desired color for matching by the colored granules, or a sampling array containing multiple color samples. The sampling spectrometer 125 may scan the sample reference and deliver spectral signals conveying coloration of the reference sample to the control unit 113, which may then use those signals to determine L*a*b* color space values informing a coloration of the reference sample for use in selecting or calculating a pigment recipe for producing colored granules with coloration matching that of the reference sample color.

Systems and methods according to the present invention use real-time color monitoring and automated color correction to produce colored granules that reliably achieve a target color with minimal color-deviation, which is expected to significantly improve manufacturing of colored plastic products. Furthermore, as the color assessment unit is a separate component from the upstream processing machine and material supply feeders, the color assessment unit may be installed in new production lines and retrofitted into existing production lines.

Advantageously, by employing an in-line color assessment unit that extracts a sampling portion of colored granules for diversion along a secondary color assessment feed path, separate from the primary production feed path, systems and methods according to the present invention are thus capable of executing fine control over optical scanning of sampling portions while maintaining optimal production throughput. For example, a user may set the color assessment unit to extract a sampling quantity of colored granules for passage along a secondary feed path, through the venturi pump and conveyor, and set a relatively lower feed rate of the conveyor for passage of the sampling quantity through the optical field of the optical spectrometer to thereby enable a high quality assessment of granule coloration; while at the same time maintaining a separate relatively higher feed rate of the remaining granules along a primary feed path, through the mouth joining the inlet chambers, to thereby achieve a target production throughput without interruption from the color assessment made by the optical spectrometer. It is thus possible to achieve improved uniformity in coloration of the granule products while maintaining high production throughput.

Although the present invention is described with reference to particular embodiments, it will be understood to those skilled in the art that the foregoing disclosure addresses exemplary embodiments only; that the scope of the invention is not limited to the disclosed embodiments; and that the scope of the invention may encompass any combination of the disclosed embodiments, in whole or in part, as well as additional embodiments embracing various changes and modifications relative to the examples disclosed herein without departing from the scope of the invention as defined in the appended claims and equivalents thereto.

For example, though the foregoing discussion addresses and example in which the color assessment unit is provided with a multi-component configuration, with the collection vessel having an overall body separate from the housings for the venturi pump and conveyor, it will be understood that the color assessment unit is not limited to such a construction and that the components may instead be configured for assembly in manner to define a single overall body or within a single housing.

Also, though the foregoing discussion addresses and example in which the collection vessel has two chambers (inlet chamber and outlet chamber), it will be understood that the collection vessel may have any number of chambers, including three or more chambers with additional chambers arranged between the inlet and outlet chambers, and including a single chamber with both the sampling outlet and the distribution outlet provided within the single chamber.

To the extent necessary to understand or complete the disclosure of the present invention, all publications, patents, and patent applications mentioned herein are expressly incorporated by reference herein to the same extent as though each were individually so incorporated. No license, express or implied, is granted to any patent incorporated or otherwise referenced herein.

The present invention is not limited to the exemplary embodiments illustrated herein, but is instead characterized by the appended claims, which in no way limit the scope of the disclosure.

1. A color assessment unit for assessing the color of colored granules, comprising:
a collection vessel for receiving colored granules from a processing machine, the collection vessel comprising a distribution outlet for feeding colored granules to a distribution line for distributing colored granules to a downstream destination and a sampling outlet for feeding colored granules to a sampling line;
an optical analyzer for assessing the coloration of colored granules, the optical analyzer comprising an optical spectrometer for measuring the coloration of colored granules and a conveyor for transporting colored granules through an optical field of the optical spectrometer;
wherein the sampling line is arranged to deliver colored granules from the sampling outlet of the collection vessel to the conveyor of the optical analyzer and the conveyor is arranged to feed colored granules back to the collection vessel for distribution via the distribution outlet.

2. The color assessment unit according to claim 1, wherein
the optical analyzer further comprises a venturi pump for generating a vacuum force in the sampling line to draw colored granules through the sampling outlet in the inlet chamber for delivery to the conveyor.

3. The color assessment unit according to claim 1, wherein
the collection vessel comprises an inlet chamber for receiving colored granules from an upstream processing machine and an outlet chamber for distributing colored granules to a downstream location, the inlet chamber and outlet chamber being in flow communication for the flow of colored granules from the inlet chamber to the outlet chamber, and the sampling outlet is located in the inlet chamber and the distribution outlet is located in the outlet chamber.

4. The color assessment unit according to claim 3, wherein
the optical analyzer further comprises a control module for controlling the venturi pump, the control module being configured to control the venturi pump to draw a first quantity of colored granules through the sampling outlet while a second quantity of colored granules flows from the inlet chamber to the outlet chamber, the first quantity being less than the second quantity.

5. The color assessment unit according to claim 3, wherein the conveyor is arranged to feed colored granules to the outlet chamber.

6. The color assessment unit according to claim 1, wherein
the conveyor is a vibratory conveyor comprising a channel and a vibratory mechanism configured to vibrate the channel for conveying colored granules through the optical field of the optical spectrometer.

7. The color assessment unit according to claim 1, wherein
the color assessment unit is configured for continuously drawing colored granules through the sampling outlet, to continuously monitor the coloration of colored granules, throughout a production run of colored granules.

8. The color assessment unit according to claim 1, wherein
the optical spectrometer is configured to transmit spectral signals to a control unit of an upstream system configured for producing colored granules, the spectral signals informing the coloration of colored granules as measured by the optical spectrometer.

9. A system for producing colored granules, comprising:
the color assessment unit according to claim 8; and
a control unit configured to control operation of a plurality of material feeders for feeding corresponding materials at predetermined feed rates in accord with a pigment recipe that is formulated for producing colored granules of a target color;
wherein the control unit is further configured to use spectral signals received from the optical spectrometer to calculate a color-deviation (ΔE) between coloration of the colored granules assessed by the optical spectrometer and the target color according to the pigment recipe, calculate a color correction to alter coloration of subsequently produced colored granules to reduce the calculated color-deviation (ΔE), and to adjust control operations of the plurality of material feeders in accord with the color correction.

10. The system according to claim 9, wherein
the control unit is configured to compare the calculated color-deviation (ΔE) with a predetermined color-deviation threshold (ΔEp), and to calculate a color correction and adjust control operations of the plurality of material feeders in accord with the color correction only when the color-deviation (ΔE) exceeds the color-deviation threshold (ΔEp).

11. The system according to claim 9, wherein
the color assessment unit is configured for continuously drawing colored granules through the sampling outlet, to continuously monitor the coloration of colored granules, throughout a production run of colored granules; and
the control unit is configured to continuously calculate color-deviations (ΔE) based on signals received from the optical spectrometer and adjust control operations of the plurality of material feeders in accord with the calculated color corrections in real-time.

12. A method of retrofitting a system for producing colored granules to utilize the color assessment unit according to claim 8, wherein:
the system comprises
a control unit configured to control operation of a plurality of material feeders for feeding corresponding materials at predetermined feed rates in accord with a pigment recipe that is formulated for producing colored granules of a target color; and
a processing machine configured to receive a combined feed of the materials fed under control of the control unit, and to produce and outputting colored granules from the combined feed;
the method comprises:
positioning the color assessment unit at the outlet of the processing machine for the reception of colored granules output from the processing machine into the collection vessel of the color assessment unit;
establishing signal communication between the optical spectrometer of the color assessment unit and the control unit of the system; and
configuring the control unit of the system to control operation of the plurality of material feeders based, in part, on spectral signals received from the optical spectrometer of the color assessment unit.
